(19) United States
(12) Patent Application Publication
(10) Pub. No.: US 2014/0107830 A1
(43) Pub. Date: Apr. 17, 2014

(54) METHOD AND DEVICE FOR DETECTING PARAMETERS OF A TRAVERSING OR CIRCULATING MATERIAL WEB IN A MATERIAL PROCESSING MACHINE

(71) Applicant: SIEMENS AKTIENGESELLSCHAFT, Munich (DE)

(72) Inventors: Peter Lange, Deggendorf (DE); Christian Merkel, Erlangen (DE); Gerd Michaelis, Möhrendorf (DE); Stefan Schwarzer, Taufkirchen (DE); Alexander Stukenkemper, Cumming, GA (US); Andreas Ziroff, München (DE)

(73) Assignee: SIEMENS AKTIENGESELLSCHAFT, Munich (DE)

(21) Appl. No.: 14/008,646

(22) PCT Filed: Mar. 15, 2012
(86) PCT No.: PCT/EP2012/054509

§ 371 Date: Dec. 11, 2013

(30) Foreign Application Priority Data
Mar. 30, 2011 (DE) 102011006391.9

(51) Int. Cl. G05B 19/418

(52) U.S. Cl. CPC G05B 19/4183
USPC 700/167

(57) ABSTRACT

A method detects parameters of a traversing or circulating material web in a material processing machine. At least one oscillation parameter of at least one transverse oscillation which occurs on the material web is detected contactlessly by at least one sensor. At least one parameter of the material web which results from said oscillation parameter is determined. Furthermore, a device detects parameters of a traversing or circulating material web in a material processing machine.

### CROSS REFERENCE TO RELATED APPLICATIONS

This application is based on and hereby claims priority to International Application No. PCT/EP2012/054509 filed on Mar. 15, 2012 and German Application No. 10 2011 006 391.9 filed on Mar. 30, 2011, the contents of which are hereby incorporated by reference.

### BACKGROUND

The invention relates to a method for detecting parameters of a traversing or circulating material web in a material processing machine. The invention further relates to a device for detecting parameters of a traversing or circulating material web in a material processing machine.

Machines for the manufacture and subsequent processing of material webs, e.g. paper webs, are usually equipped with tension measuring equipment which detects a tensile force and/or tensile stress. Detection of these values is necessary in order to ensure constant web tension of the material web during the manufacturing or processing process, this being important for high product quality and productivity. In conventional measuring equipment, the measurement takes place by transferring a force to a tensile force pick-up, which is preferably arranged at a rolling contact bearing of the machine. Such measuring pick-ups have an active mechanical connection to the machine and are exposed to external physical influences such as e.g. temperature fluctuations, mechanical oscillations of the machine, distortion of rollers of the machine and/or imbalances, which reduce measuring accuracy or corrupt measuring results.

DE 197 07 691 A1 discloses a method and a device for measuring a tensile stress distribution over a width of a metal strip, wherein a force is exerted on the metal strip by an electromagnetic field. The resulting deflection of the metal strip is measured and used to calculate the tensile stress distribution.

GB 2 082 323 A discloses a method and a device for measuring a tensile stress in a material web, wherein transverse waves are generated in the material web by ultrasound, the propagation speed of these waves is measured and the tensile stress is determined therefrom.

EP 1 985 990 A2 discloses a method and a device for determining the strength of a fibrous material web from a variable that is representative of an elasticity modulus of the fibrous material web. This variable is determined by ultrasound signals that are applied to the fibrous material web.

DE 10 2007 032 095 A1 discloses a winding device for unwinding a material web from a full reel, comprising a sensor device for detecting oscillations that are substantially perpendicular to a roller axis of a material web roller.

WO 96/11396 A1 discloses a system for measuring elastic properties of a moving paper web. In this case, provision is made for generating an ultrasound wave in the paper web and for determining the propagation speed of said wave in the paper web.

US 2001/0003112 A1 discloses a method for detecting vibrations in a roller, in particular at a surface of the roller.

U.S. Pat. No. 6,792,807 B2 discloses a method and a device for detecting seals of a moving plastic film for the manufacture of bags. In this case, a force is exerted on the film, captured by a force sensor and analyzed by a control unit.

U.S. Pat. No. 6,324,912 B1 discloses a system for detecting flaws in a medium by an acoustic Doppler effect resulting from the relative movement of the system and the medium. In this case, an acoustic signal is passed through the medium and a Doppler-shifted signal is detected and analyzed.

U.S. Pat. No. 4,688,423 discloses a system for measuring the speed of vibrations in a moving material web, in particular a paper web. In this case, vibrations are generated in the material web and their propagation speed is determined.

WO 91/17435 A1 discloses a method for determining the elasticity modulus of a moving flexible material. In this case, the material is subjected to an ultrasound wave and the scattering of the ultrasound wave by the material and the propagation speed of the ultrasound wave are detected and analyzed.

U.S. Pat. No. 5,025,665 discloses a system for the contactless measurement of a material strength in a material web. In this case, an ultrasound wave is generated in the material by a first laser beam and the propagation speed of the ultrasound wave is determined and analyzed by a second laser beam directed at the material.

### SUMMARY

One potential object is therefore to specify an improved method and an improved device for detecting parameters of a traversing or circulating material web in a material processing machine.

The inventors propose a method for detecting parameters of a traversing or circulating material web in a material processing machine. In the method, at least one oscillation parameter of at least one transverse oscillation occurring at the material web is contactlessly detected by at least one sensor, and at least one parameter relating to the material web and resulting from said oscillation parameter is determined. This allows non-wearing or virtually non-wearing detection of parameters of the material web. In particular, the contactlessly functioning sensor is insensitive to external influences such as e.g. temperature fluctuations, mechanical oscillations of the machine, distortion of rollers of the machine and/or imbalances. Measuring accuracy can therefore be increased and consequently a constant web tension of the material web can be set during the manufacturing or processing process, thereby improving the quality and the manufacturing speed of the material web.

In a preferred embodiment, oscillations occurring in a longitudinal and/or cross direction of the material web due to self-excitation are detected as transverse oscillations. This self-excitation may be caused by vibrations of the material processing machine itself or by imbalances in the rollers via which the material web is guided in the material processing machine.

In an alternative embodiment, the transverse oscillations of the material web occurring in a longitudinal and/or cross direction are separately excited. Such separate excitation is applicable, for example, if sufficiently accurate oscillation parameters cannot be detected by self-excitation. This may be necessary due to e.g. an incorrect frequency, narrow bandwidth, low amplitude and/or lack of repeatability of the self-excitation.

In an advantageous embodiment, the separate excitation of transverse oscillations of the material web is effected by applying a sound pressure. In this case, a sound pressure is directed at or applied to the material web at least sectionally using a suitable mechanism, wherein amplitude, directivity, frequency, bandwidth, pulse shape and/or pulse repeat rate can be variably adapted to the respective material web and the transverse oscillations that are to be generated.

In an advantageous embodiment, the separate excitation of transverse oscillations of the material web is effected by mechanical excitation of the material web. In this case, suitable mechanism are used to selectively apply vibrations to the material web, said vibrations resulting in transverse oscillations.

A tensile force and/or tensile stress in a direction of movement of the material web, a speed, an elasticity modulus in a direction of movement of the material web, a relative humidity and/or a thickness of the material web are advantageously determined as parameters of the material web by a predetermined and in particular mathematical calculation model of the restrained and oscillating material web. Using these parameters, it is possible to set a constant web tension of the material web during the manufacturing or processing process.

By virtue of the device for detecting parameters of a traversing or circulating material web in a material processing machine, at least one oscillation parameter of at least one transverse oscillation occurring at the material web can be contactlessly detected by at least one sensor, and at least one parameter relating to the material web and resulting from this oscillation parameter can be determined by a control unit. The oscillation parameters of the transverse oscillations can therefore be detected without being influenced by external influences.

In a particularly preferred development, a plurality of sensors are disposed along the material web, longitudinally and/or crosswise relative to the direction of movement, and aligned therewith. By virtue of a plurality of sensors, these being aligned with different surface areas of the material web, it is easily possible to detect a propagation direction and a propagation speed of the transverse oscillations.

The sensor or sensors advantageously take the form of radar sensors, Doppler radar sensors, ultrasound sensors and/or laser sensors. These contactless sensors are insensitive to mechanical influences such as vibrations, dust deposits, temperature fluctuations and/or high air humidity, and are non-wearing.

### BRIEF DESCRIPTION OF THE DRAWINGS

These and other objects and advantages of the present invention will become more apparent and more readily appreciated from the following description of the preferred embodiments, taken in conjunction with the accompanying drawings of which:

FIG. 1 schematically shows a material processing machine according to the related art,

FIG. 2 schematically shows a material processing machine featuring a proposed device for detecting parameters of a traversing or circulating material web, and

FIG. 3 schematically shows a method flow diagram of a proposed method.

### DETAILED DESCRIPTION OF THE PREFERRED EMBODIMENT

Reference will now be made in detail to the preferred embodiments of the present invention, examples of which are illustrated in the accompanying drawings, wherein like reference numerals refer to like elements throughout.

Corresponding parts are denoted by the same reference signs in all of the figures.

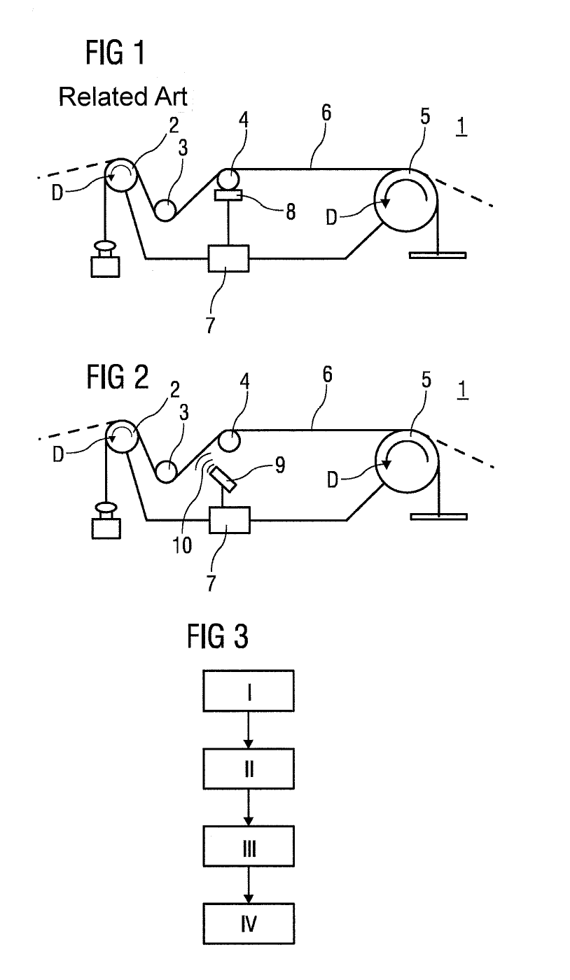

FIG. 1 schematically illustrates a material processing machine 1 according to the related art. Such a material processing machine 1 comprises a plurality of rollers 2, 3, 4, 5, each of which may have a different diameter, via which a material web 6 is guided. Individual rollers 2, 5 can be actively driven in this case, wherein different speeds of rotation or rotary speeds D can be set at the individual driven rollers 2, 5. A web tension of the material web 6 can be influenced by varying the speeds of rotation or rotary speeds D. The speeds of rotation or rotary speeds D can be adjusted manually by an operator or automatically by a control unit 7.

A tensile force and/or tensile stress in a direction of movement (also called direction of travel or longitudinal direction) of the material web 6 is conventionally determined by a tensile force pick-up 8, which is preferably arranged at a rolling contact bearing of the roller 4 of the material processing machine 1. Such a tensile force pick-up 8 has an active mechanical connection to the material processing machine 1 and is exposed to external physical influences such as e.g. temperature fluctuations, mechanical oscillations of the material processing machine 1, distortion of rollers of the material processing machine 1, dirt accumulation and/or imbalances, which reduce measuring accuracy or corrupt measuring results.

The rotary speed D of the driven rollers 2, 5 can be set manually or automatically with reference to the tensile force Z and/or tensile stress that has been determined, such that a constant web tension of the material web 6 is possible during the manufacturing or processing process.

The material web 6 preferably takes the form of a conventional paper web and the material processing machine 1 takes the form of a paper machine, coating machine, rewinder and/or roll cutting machine, for example.

FIG. 2 schematically illustrates a material processing machine 1 featuring a device proposed by the inventors for detecting parameters of a traversing material web 6. Alternatively, the material processing machine can be designed for a circulating material web (not shown in detail). The proposed device for detecting the parameters relating to a circulating material web does not substantially differ from that for detecting parameters relating to a traversing material web 6. Only the position of the device may be different. The components are substantially identical.

The material processing machine 1 according to FIG. 2 substantially corresponds to the material processing machine 1 illustrated in FIG. 1, with the difference that no tensile force pick-up 8 is arranged at the rolling contact bearing of the roller 4.

A plurality of sensors 9 are disposed longitudinally and/or crosswise relative to the direction of movement of the material web 6, wherein a detection zone 10 of the sensors 9 is aligned with the material web 6 and detects so-called transverse oscillations occurring there. In a particularly advantageous manner, a propagation direction and/or propagation speed of the transverse oscillations can easily be detected by a plurality of sensors 9 which are aligned with different surface areas of the material web 6 in each case. The propagation speed of the transverse oscillations is directly related to the web tension of the material web 6 in this case and therefore said web tension can be determined from the propagation speed of the transverse oscillations. The sensors 9 can detect different oscillation parameters of the transverse oscillations, such as e.g. a frequency, amplitude and/or phase. To this end, the sensors 9 are aligned longitudinally or crosswise relative to the direction of movement of the material web 6, depending on the direction of the wave propagation of the transverse oscillations.

The material web 6 is restrained at both ends in the direction of tension between the rollers 2 and 5. The material web 6 is not restrained along its longitudinal sides. Normal transverse oscillations can therefore propagate on the material web 6, which is traversing at a predefinable speed, in the direction of travel or movement (=longitudinal direction), i.e. between the restrained ends, and crosswise relative to the direction of travel or movement (=cross direction), i.e. between the longitudinal sides. Continuous and stationary waves of transverse oscillations can occur in a longitudinal direction due to the restraint and the web movement. In a cross direction, continuous waves of the transverse oscillations can occur and can be reflected at the longitudinal sides.

The transverse oscillations of the material web 6 may be self-exited or separately excited. Self-excited transverse oscillations occur e.g. due to vibrations of the material processing machine 1 or individual machine parts, e.g. as a result of imbalance in at least one of the rollers 2 to 5 via which the material web 6 is guided in the material processing machine 1, or as a result of turbulent airflow along the material web 6.

If it is not possible to detect sufficiently accurate oscillation parameters of the transverse oscillations by such self-excitation, separate excitation can be applied. This may be necessary due to incorrect frequency, narrow bandwidth, low amplitude and/or lack of repeatability of the self-excitation, for example. For this purpose, the separately excited transverse oscillations are induced by sound pressure or mechanically, for example. In this case, a sound pressure is directed at or applied to the material web at least sectionally using a suitable mechanism, wherein amplitude, directivity, frequency, bandwidth, pulse shape and/or pulse repeat rate can be variably adapted to the respective material web and the transverse oscillations that are to be generated.

In an alternative embodiment, the separate excitation of transverse oscillations of the material web 6 is produced by mechanical excitation of the material web 6. In this case, suitable mechanism are used to selectively apply vibrations to the material web 6, said vibrations resulting in transverse oscillations.

Different transverse oscillations can be selectively and repeatedly excited by selecting the location and/or direction in which they are triggered.

The sensors 9 advantageously take the form of conventional radar sensors, Doppler radar sensors, ultrasound sensors and/or laser sensors. These contactless sensors 9 are insensitive to mechanical influences such as vibrations, dust deposits, temperature fluctuations and/or high air humidity, and are non-wearing.

In a particularly advantageous development, Doppler radar sensors are used as sensors 9 because they can directly measure the amplitude and phase of a transverse oscillation of a reflective material. These Doppler radar sensors preferably operate in a frequency range of 77 GHz in this case.

On the basis of a predetermined and in particular mathematical calculation model of the restrained and oscillating material web 6, which model is preferably stored in the control unit 7, the recorded oscillation parameters of the transverse oscillations can be used to determine, as parameters of the material web 6, a tensile force and/or tensile stress in a direction of movement of the material web 6, a speed, an elasticity modulus in a direction of movement of the material web 6, a relative humidity and/or a thickness of the material web 6.

For some of these parameters, it may be necessary to arrange and distribute sensors 9 at a plurality of sections of the material web 6, i.e. between different roller pairs, and to extend the mathematical calculation model accordingly, e.g. in order to obtain the mass flow. In this case, the parameters and/or the parameter combinations which can be determined with sufficient accuracy are dependent on the number and the position of the sensors 9 and on the dimensional coordination of the mathematical calculation model of the material web 6.

FIG. 3 schematically illustrates a method flow diagram of the proposed method. As part of the method, at least one separately excited transverse oscillation is applied to the material web 6 in a first process I.

In a second process II, at least one oscillation parameter of a transverse oscillation occurring at the material web 6 is contactlessly detected by at least one sensor 9 and transferred to the control unit 7, this being coupled to the sensor 9.

In a third process III, parameters of the material web 6 are determined on the basis of the mathematical calculation model of the restrained traversing and oscillating material web 6, said model being stored in the control unit 7, and the oscillation parameters that have been detected.

In a fourth process IV, the determined parameters of the material web 6 are visually displayed to an operator of the material processing machine 1, wherein the operator controls or adjusts the material processing machine 1 manually.

In an alternative, preferred embodiment, the calculated parameters of the material web 6 are used to control and/or adjust the material processing machine 1 automatically.

The invention has been described in detail with particular reference to preferred embodiments thereof and examples, but it will be understood that variations and modifications can be effected within the spirit and scope of the invention covered by the claims which may include the phrase “at least one of A, B and C” as an alternative expression that means one or more of A, B and C may be used, contrary to the holding in Superguide v. DIRECTV, 69 USPQ2d 1865 (Fed. Cir. 2004).

1-11. (canceled)

12. A method for obtaining parameters of a traversing or circulating material web in a material processing machine, comprising:
contactlessly detecting an oscillation parameter of a transverse oscillation occurring at the material web, the oscillation parameter being detected with a sensor, the oscillation parameter being at least one parameter selected from the group consisting of a frequency of the transverse oscillation, an amplitude of the transverse oscillation and a phase of the transverse oscillation; and
determining a parameter relating to the material web from the oscillation parameter, the parameter relating to the material web being at least one parameter selected from the group consisting of a tensile force in a direction of movement of the material web, a tensile stress in the direction of movement of the material web, a speed in the direction of movement of the material web, an elasticity modulus in the direction of movement of the material web, a relative humidity of the material web, and a thickness of the material web, wherein
the transverse oscillation is an oscillation occurring in a longitudinal and/or cross direction at the material web, and
the transverse oscillation is due to self-excitation or a separate mechanical excitation of the material web.

13. The method as claimed claim 12, wherein
the material web is a restrained and oscillating material web,
the parameter relating to the material web is determined from the oscillation parameter using a calculation model of the restrained and oscillating material web, and
the calculation model is stored in a control unit.

14. The method as claimed in claim 12, wherein
the material web is a paper web,
the material processing machine is a paper manufacturing machine, a coating machine, a rewinder or a roll cutting machine, and
the method further comprises controlling the material processing machine based on the parameter relating to the web.

15. The method as claimed in claim 12, wherein
the transverse oscillation is due to a separate mechanical excitation of the material web, and
a sound pressure is applied to the material web to cause the mechanical excitation.

16. A device to obtain parameters of a traversing or circulating material web in a material processing machine, comprising:
a sensor to contactlessly detect an oscillation parameter of a transverse oscillation occurring at the material web, the sensor being selected from the group consisting of a radar sensor, a Doppler radar sensor, an ultrasound sensor and a laser sensor, the oscillation parameter being at least one parameter selected from the group consisting of a frequency of the transverse oscillation, an amplitude of the transverse oscillation and a phase of the transverse oscillation, the transverse oscillation occurring as a result of self-excitation of the material web or as a result of mechanical excitation of the material web; and
a control unit coupled to the sensor, to determine a parameter of the material web based on data from the sensor regarding the oscillation parameter, the parameter of the material web being at least one parameter selected from the group consisting of a tensile force in a direction of movement of the material web, a tensile stress in the direction of movement of the material web, a speed in the direction of movement of the material web, an elasticity modulus in the direction of movement of the material web, a relative humidity of the material web and a thickness of the material web.

17. The device as claimed in claim 16, wherein
a plurality of sensors are disposed along the material web at different locations in the material processing machine,
each sensor is positioned longitudinally or crosswise relative to the direction of movement of the material web, and
the sensors are aligned with the material web.

18. The device as claimed in claim 17, wherein
each sensor is arranged between two different adjacently disposed rollers in the material processing machine.

19. The device as claimed in claim 16, wherein
the material web is a restrained and oscillating material web, and
a calculation model of the restrained and oscillating material web is stored in the control unit to determine the parameter of the material web based on the data from the sensor regarding the oscillation parameter.

20. The device as claimed in claim 16, wherein
the sensor is arranged between two adjacently disposed rollers in the material processing machine.

21. The device as claimed in claim 16, wherein
the transverse oscillation occurs as the result of mechanical excitation of the material web, and
a sound pressure is applied to the material web to cause the mechanical excitation.
